(19) United States
(12) Patent Application Publication
(10) Pub. No.: US 2018/0253106 A1
(43) Pub. Date: Sep. 6, 2018

(54) PERIPHERY MONITORING DEVICE

(71) Applicant: AISIN SEIKI KABUSHIKI KAISHA, Kariya-shi (JP)

(72) Inventors: Yoji INUI, Ama-gun (JP); Tetsuya MARUOKA, Okazaki-shi (JP); Kazuya WATANABE, Anjo-shi (JP); Kinji YAMAMOTO, Anjo-shi (JP); Itsuko FUKUSHIMA, Anjo-shi (JP); Takuya HASHIKAWA, Nagoya-shi (JP); Naotaka KUBOTA, Aioi-shi (JP); Takashi HIRAMAKI, Nagoya-shi (JP); Osamu KIMURA, Ichinomiya-shi (JP)

(73) Assignee: AISIN SEIKI KABUSHIKI KAISHA, Kariya-shi (JP)

(21) Appl. No.: 15/890,700

(22) Filed: Feb. 7, 2018

(30) Foreign Application Priority Data
Mar. 1, 2017 (JP) 2017-038796

(51) Int. Cl. G05D 1/02; B60R 1/00; B60W 10/18; B60W 10/20; B60W 30/18

(52) U.S. Cl. CPC G05D 1/0246; B60W 2540/04; B60W 10/18; B60W 10/20; B60W 30/18009; G05D 2201/0213; B60R 2300/105; B60R 2300/303; B60R 2300/8066; B60R 2300/808; B60W 2420/42; B60W 2710/18; B60W 2710/20; B60W 2720/106; B60R 1/003

(57) ABSTRACT

A periphery monitoring device includes: a first acquisition unit configured to acquire a first image in which a first connection device provided in a vehicle and a second connection device provided in a towed vehicle are captured; a second acquisition unit configured to acquire height information of the second connection device; and a guidance controller configured to calculate a positional relationship between the first connection device and the second connection device based on a display position of the second connection device in the first image and the height information, calculate a path of the vehicle until the first connection device and the second connection device are connected to each other based on the positional relationship, and to guide the vehicle along the path.

### CROSS REFERENCE TO RELATED APPLICATIONS

This application is based on and claims priority under 35 U.S.C. § 119 to Japanese Patent Application 2017-038796, filed on Mar. 1, 2017, the entire contents of which are incorporated herein by reference.

### TECHNICAL FIELD

Embodiments of this disclosure relate to a periphery monitoring device.

### BACKGROUND DISCUSSION

Conventionally, there has been known a technology of capturing an image of the environment around a vehicle with an imaging device provided in the vehicle and providing a captured image to a driver via a display screen provided inside the vehicle cabin. In an operation of connecting a trailer (towed vehicle) to the vehicle, the driver may use an image displayed on the display screen to check a positional relationship between the vehicle and the trailer. See JP Patent 3945467 (Reference 1) and JP 2006-001533 A (Reference 2).

Thus, a need exists for a periphery monitoring device which is not susceptible to the drawback mentioned above.

### SUMMARY

As one example, a periphery monitoring device according to an aspect of this disclosure includes a first acquisition unit configured to acquire a first image in which a first connection device provided in a vehicle and a second connection device provided in a towed vehicle are captured, a second acquisition unit configured to acquire height information of the second connection device, and a guidance controller configured to calculate a positional relationship between the first connection device and the second connection device based on a display position of the second connection device in the first image and the height information, calculate a path of the vehicle until the first connection device and the second connection device are connected to each other based on the positional relationship, and guide the vehicle along the path.

Therefore, since the periphery monitoring device may automatically guide the vehicle in the connecting operation, the operation of interconnecting the vehicle and the trailer may be easily performed.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a vehicle, which is mounted with a periphery monitoring device according to a first embodiment, in a state in which a portion of the interior of the vehicle is viewed therethrough;

FIG. 2 is a view illustrating a configuration of a periphery monitoring system according to the first embodiment provided in the vehicle;

FIG. 3 is a view illustrating an example of a trailer to be connected to the vehicle according to the first embodiment;

FIG. 4 is a view for explaining an image area of a camera according to the first embodiment, which captures an image of the rear side of the vehicle;

FIG. 5 is a block diagram illustrating a functional configuration of an ECU according to the first embodiment;

FIG. 6 is a view for explaining height information of a hitch ball;

FIG. 7 is a flowchart explaining an operation of the ECU according to the first embodiment;

FIG. 8 is a flowchart explaining an operation of the ECU according to the first embodiment;

FIG. 9 is a flowchart explaining an operation of the ECU according to the first embodiment;

FIG. 10 is a view illustrating a display example of a display screen by the ECU according to the first embodiment;

FIG. 11 is a view illustrating a display example of the display screen by the ECU according to the first embodiment;

FIG. 12 is a view illustrating a display example of the display screen by the ECU according to the first embodiment;

FIG. 13 is a view illustrating a display example of the display screen by the ECU according to the first embodiment;

FIG. 14 is a view illustrating a display example of the display screen by the ECU according to the first embodiment;

FIG. 15 is a view for explaining an example of a method of specifying a position in a three-dimensional space;

FIG. 16 is a view illustrating a display example of the display screen by the ECU according to the first embodiment;

FIG. 17 is a view illustrating a display example of the display screen by the ECU according to the first embodiment;

FIG. 18 is a view illustrating a display example of the display screen by the ECU according to the first embodiment;

FIG. 19 is a view illustrating a display example of the display screen by the ECU according to the first embodiment;

FIG. 20 is a view illustrating a display example of the display screen by the ECU according to the first embodiment;

FIG. 21 is a view illustrating an example of the area represented by a wide-area bird's-eye view image according to the first embodiment;

FIG. 22 is a view illustrating an example of the area represented by a wide-area bird's-eye view image according to the first embodiment;

FIG. 23 is a view illustrating a display example of the display screen by the ECU according to the first embodiment; and

FIG. 24 is a view illustrating a display example of the display screen by the ECU according to the first embodiment.

### DETAILED DESCRIPTION

Hereinafter, an example in which a periphery monitoring device of the embodiment disclosed here is mounted in a vehicle 1 will be described.

### First Embodiment

The vehicle 1 of the embodiment may be, for example, an automobile having an internal combustion engine (not illustrated) as a drive source, i.e. an internal combustion automobile, may be an automobile having an electric motor (not illustrated) as a drive source, i.e. an electric automobile or a fuel cell automobile, may be a hybrid automobile having both the internal combustion engine and the electric motor as a drive source, or may be an automobile having any other drive source. In addition, the vehicle 1 may be equipped with any of various transmission devices, and may be equipped with various devices, for example, systems or parts required to drive the internal combustion engine or the electric motor. In addition, for example, the types, the number, and the layout of devices related to the driving of wheels 3 in the vehicle 1 may be set in various ways.

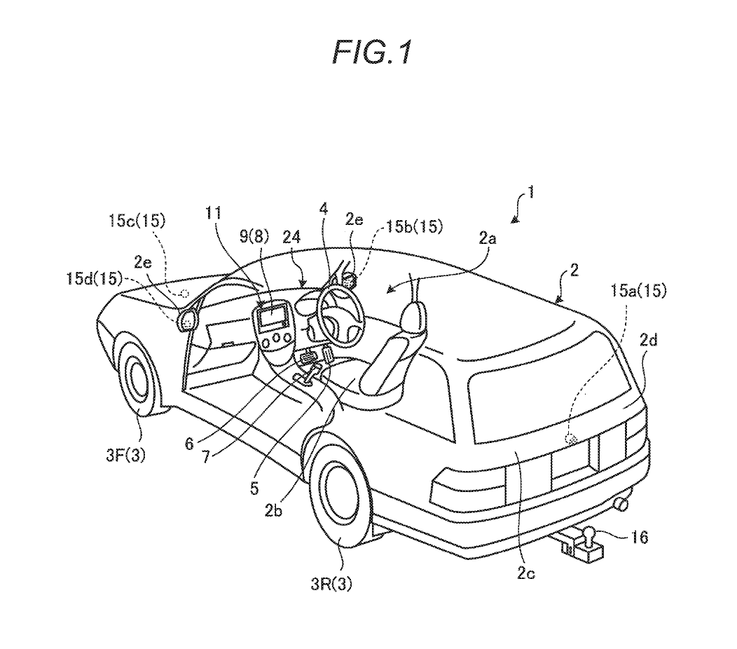

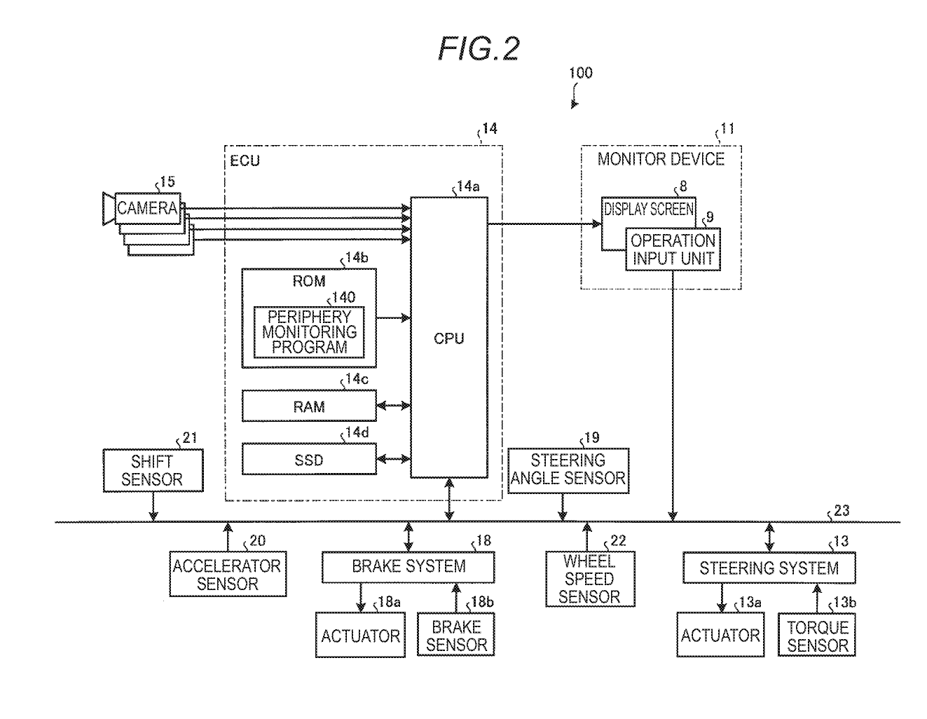

FIG. 1 is a perspective view illustrating an example of the vehicle 1, which is mounted with a periphery monitoring device according to the first embodiment, in a state in which a portion of a vehicle cabin 2a of the vehicle 1 is viewed therethrough. FIG. 2 is a view illustrating a configuration of a periphery monitoring system 100 according to the first embodiment provided in the vehicle 1.

As illustrated in FIG. 1, a vehicle body 2 forms the vehicle cabin 2a on which a passenger (not illustrated) gets. In the vehicle cabin 2a, for example, a steering unit 4, an acceleration operation unit 5, a braking operation unit 6, and a speed-change operation unit 7 are provided in a state of facing a seat 2b of a driver as a passenger. The steering unit 4 is, for example, a steering wheel that protrudes from a dashboard 24, the acceleration operation unit 5 is, for example, an accelerator pedal that is located at the driver's feet, the braking operation unit 6 is, for example, a brake pedal that is located at the driver's feet, and the speed-change operation unit 7 is, for example, a shift lever that protrudes from a center console. Here, the steering unit 4, the acceleration operation unit 5, the braking operation unit 6, and the speed-change operation unit 7 are not limited thereto.

In addition, a display screen 8 is provided in the vehicle cabin 2a. The display screen 8 is, for example, a liquid crystal display (LCD) or an organic electroluminescent display (OELD). In addition, the display screen 8 is covered with a transparent operation input unit 9, for example, a touch panel. The passenger may visually recognize an image displayed on the display screen 8 through the operation input unit 9. In addition, the passenger may execute an operation input by operating, i.e. touching, pushing, or moving the operation input unit 9 with, for example, a finger at a position that corresponds to the image displayed on the display screen 8. The display screen 8, the operation input unit 9, and the like are provided, for example, in a monitor device 11, which is located in the center portion of the dashboard 24 in the vehicle width direction, i.e. in the transverse direction. The monitor device 11 may include an operation input unit (not illustrated) such as, for example, a switch, a dial, a joystick, or a push button. The monitor device 11 may be combined and used with, for example, a navigation system or an audio system.

In addition, as illustrated in FIG. 1, the vehicle 1 is, for example, a four-wheel vehicle. The vehicle 1 includes two left and right front wheels 3F and two left and right rear wheels 3R. All of the fourth wheels 3 may be configured to be steerable. As illustrated in FIG. 2, the vehicle 1 includes a steering system 13, which steers at least two wheels 3. The steering system 13 includes an actuator 13a and a torque sensor 13b. The steering system 13 is electrically controlled by, for example, an electronic control unit (ECU) 14 to operate the actuator 13a. The steering system 13 is, for example, an electric power steering system or a steer-by-wire (SBW) system. The steering system 13 supplements a steering force by adding a torque, i.e. an assist torque to the steering unit 4 by the actuator 13a, or steers the wheels 3 by the actuator 13a.

In addition, as illustrated in FIG. 1, a hitch ball 16 is provided at the back of the vehicle 1. The hitch ball 16 is a connection device that connects a trailer, which is a towed target, to the vehicle 1.

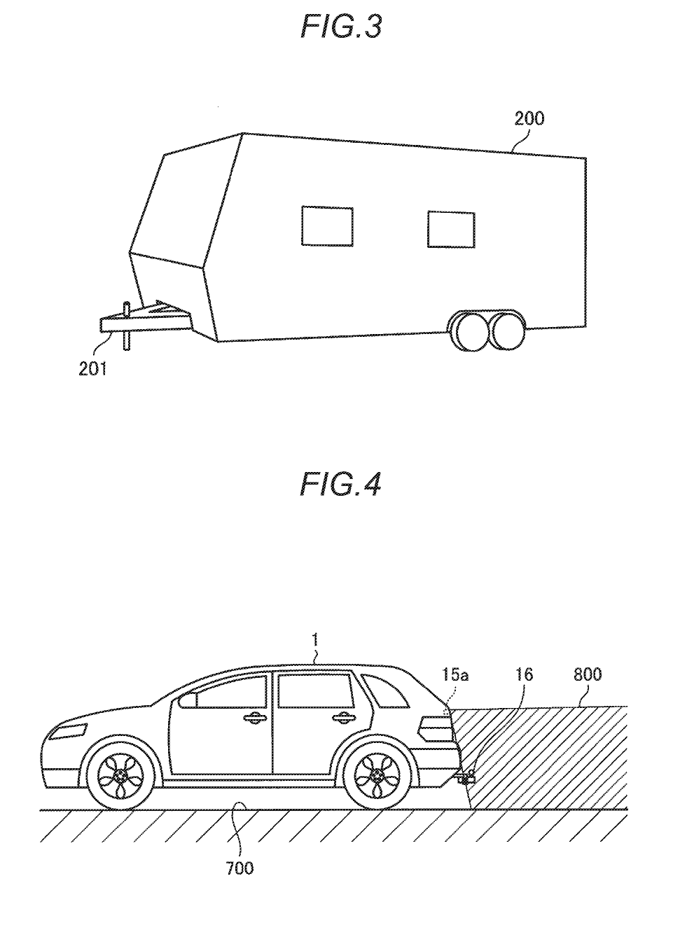

FIG. 3 is a view illustrating an example of a trailer 200, which is a towed target. In this example, the trailer 200 is a camping trailer, but the trailer 200 as the towed target is not limited to the camping trailer. A hitch coupler 201 is attached to the front end portion of the trailer 200. The hitch coupler 201 is a trailer 200 side connection device and is connectable to the hitch ball 16. In a connecting operation, the vehicle 1 is moved in such a manner in which the hitch ball 16 is located immediately below the hitch coupler 201, and thereafter the hitch coupler 201 and the hitch ball 16 are connected to each other.

Here, the hitch ball 16 and the hitch coupler 201 are an example of a combination of the connection devices. For example, any other connection devices such as, for example, a combination of a fifth wheel and a king pin, may be employed.

In addition, as illustrated in FIG. 1, the vehicle body 2 is provided with plural cameras 15, for example, four cameras 15a to 15d. Each camera 15 is, for example, an imaging device in which an imaging element such as, for example, a charge coupled device (CCD) or a CMOS image sensor (CIS) is mounted. Each camera 15 may output video images (captured images) at a predetermined frame rate. Each camera 15 may include a wide-angle lens or a fish-eye lens, and may capture an image of, for example, a range from 140° to 220° in the horizontal direction. Thus, each camera 15 sequentially captures an image of the environment around the vehicle 1 and outputs a captured image.

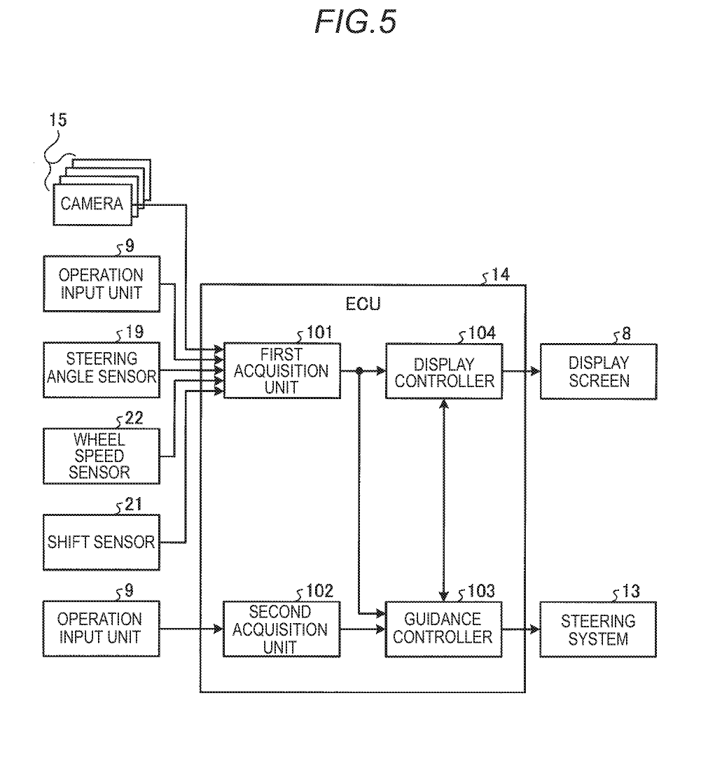

The camera 15a is located, for example, on a rear end 2c of the vehicle body 2 and is provided on a wall portion below a rear window of a rear hatch door 2d. As illustrated in FIG. 4, the optical axis of the camera 15a is set to be more slightly directed toward a ground 700 than the horizontal direction so that the hitch ball 16 enters an imaging area 800 of the camera 15a. The camera 15b is provided, for example, on a door mirror 2e on the right side of the vehicle body 2. The camera 15c is provided, for example, on the front side of the vehicle body 2, that is, on a front bumper, a front grill, or the like in the vehicle longitudinal direction. The camera 15d is provided, for example, on a door mirror 2e on the left side of the vehicle body 2.

As illustrated in FIG. 2, the periphery monitoring system 100 includes, for example, a brake system 18, a steering angle sensor 19, an accelerator sensor 20, a shift sensor 21, and a wheel speed sensor 22, in addition to the monitor device 11, the steering system 13, and the ECU 14. The monitor device 11, the steering system 13, the ECU 14, the brake system 18, the steering angle sensor 19, the accelerator sensor 20, the shift sensor 21, and the wheel speed sensor 22 are connected to an in-vehicle network 23 as an electric communication line. The in-vehicle network 23 is configured as, for example, a controller area network (CAN). The ECU 14 may control, for example, the steering system 13 and the brake system 18 by sending a control signal through the in-vehicle network 23. In addition, the ECU 14 may receive sensor values of, for example, the torque sensor 13b, a brake sensor 18b, the steering angle sensor 19, the accelerator sensor 20, the shift sensor 21, and the wheel speed sensor 22, or operation information of, for example, the operation input unit 9 through the in-vehicle network 23.

The brake system 18 includes, for example, an anti-lock brake system (ABS) that suppresses the locking of a brake, an electronic stability control (ESC) that suppresses the side slipping of the vehicle 1 during cornering, an electric brake system that increases a braking force (executes brake assistance), or a brake-by-wire (BBW). The brake system 18 applies a braking force to the wheel 3 and further applies the braking force to the vehicle 1 via an actuator 18a. The brake sensor 18b is, for example, a sensor that detects the position of a movable element (e.g., a brake pedal) of the braking operation unit 6.

The steering angle sensor 19 is, for example, a sensor that detects the steering amount of the steering unit 4 of, for example, a steering wheel. The ECU 14 acquires, for example, the amount of steering of the steering unit 4 by the driver or the steering amount of each wheel 3 during automatic steering from the steering angle sensor 19 and executes various controls.

The accelerator sensor 20 is, for example, a sensor that detects the position of a movable element (e.g., an accelerator pedal) of the acceleration operation unit 5.

The shift sensor 21 is, for example, a sensor that detects the position (range) of a movable element of the speed-change operation unit 7. The shift sensor 21 detects the range of a movable element among plural ranges including, for example, a parking range, a reverse range, a drive range, and a neutral range.

The wheel speed sensor 22 is a sensor that detects the amount of rotation of the wheel 3 or the number of revolutions per unit time. The wheel speed sensor 22 is disposed on each wheel 3 and outputs, as a sensor value, the number of wheel speed pulses indicating the number of revolutions detected from each wheel 3. The ECU 14 calculates, for example, the amount of movement of the vehicle 1 based on a sensor value acquired from the wheel speed sensor 22 and executes various controls.

The ECU 14 is an example of a periphery monitoring device. The ECU 14 includes, for example, a central processing unit (CPU) 14a, a read only memory (ROM) 14b, a random access memory (RAM) 14c, and a solid state drive (SSD) 14d. The CPU 14a is a calculation device, and the ROM 14b, the RAM 14c, and the SSD 14d are storage devices. That is, the ECU 14 has a computer hardware configuration. In addition, the ECU 14 may be configured by plural computers.

The CPU 14a realizes a function as the periphery monitoring device by executing a periphery monitoring program 140, which is installed and stored in the ROM 14b. The periphery monitoring program 140 may be installed in the SSD 14d, instead of the ROM 14b. The RAM 14c temporarily stores various types of data used for calculation in the CPU 14a. The SSD 14d is a rewritable nonvolatile storage device, and may store data even when the power supply of the ECU 14 is turned off. The CPU 14a, the ROM 14b, the RAM 14c, and the like may be integrated in the same package. In addition, the ECU 14 may be configured to use, instead of the CPU 14a, for example, another logic calculation processor such as, for example, a digital signal processor (DSP) or a logic circuit. In addition, a hard disk drive (HDD) may be provided instead of the SSD 14d, and the SSD 14d or the HDD may be provided separately from the ECU 14.

The periphery monitoring program 140 is a file in a computer-installable or computer-executable format and may be provided by being recorded in a computer-readable recording medium such as a CD-ROM, flexible disk (FD), CD-R, a digital versatile disk (DVD), or a flash memory.

In addition, the periphery monitoring program 140 may be configured to be provided by being stored in a computer connected to a network such as, for example, the Internet and being downloaded via the network. In addition, the periphery monitoring program 140 may be provided or distributed via a network such as, for example, the Internet.

The ECU 14 may execute a calculation processing or an image processing based on captured images obtained by the plural cameras 15 so as to generate an image having a wider viewing angle or to generate a virtual bird's-eye view image of the vehicle 1 viewed from above. In addition, the ECU 14 executes a calculation processing or an image processing on data of a wide-angle image obtained by each camera 15 to generate an image of a cut-out specific area, to generate an image representing only a specific area, or to generate an image in which only a specific area is emphasized. In addition, the ECU 14 may execute conversion from a captured image into a virtual image as if the image is captured from a viewpoint (virtual viewpoint) different from the imaging viewpoint of the camera 15 (viewpoint conversion). By displaying the acquired captured image on the display screen 8, for example, the ECU 14 may provide periphery monitoring information, which enables safety checking on the right side or the left side of the vehicle 1 or safety checking around the vehicle by overlooking the vehicle 1. In addition, when the vehicle 1 moves backward, the ECU 14 displays an image representing the environment in the rear of the vehicle 1 on the display screen 8 based on a captured image obtained by the camera 15a. A mode in which an image representing the environment in the rear side of the vehicle 1 is displayed on the display screen 8 is referred to as a “rear view mode.” In addition, the captured image obtained by the camera 15a is referred to as a “rear image.”

Here, when connecting the trailer 200 to the vehicle 1, the driver moves the vehicle 1 to the position at which the back of the vehicle 1 substantially faces the front side of the trailer 200, and then moves the vehicle 1 backward so as to move the vehicle 1 to the position at which the hitch ball 16 and the hitch coupler 201 may be connected to each other. The ECU 14 as the periphery monitoring device of the embodiment disclosed here may operate in the rear view mode when the vehicle 1 moves backward and may automatically guide the vehicle 1 to the position at which the hitch ball 16 and the hitch coupler 201 may be connected to each other.

FIG. 5 is a block diagram illustrating a functional configuration of the ECU 14 according to the first embodiment. The ECU 14 functions as a first acquisition unit 101, a second acquisition unit 102, a guidance controller 103, and a display controller 104. The CPU 14a reads and executes the periphery monitoring program 140 from the ROM 14b, thereby implementing functions as the first acquisition unit 101, the second acquisition unit 102, the guidance controller 103, and the display controller 104.

The first acquisition unit 101 acquires a captured image from each camera 15. In particular, in the rear view mode, the first acquisition unit 101 acquires, from the camera 15a, a rear image in which the images of the hitch ball 16 and the hitch coupler 201 are captured.

In addition, in the rear view mode, the first acquisition unit 101 acquires an input to specify the hitch ball 16 and the hitch coupler 201. In one example, the display controller 104 displays, on the display screen 8, a rear image in which the images of the hitch ball 16 and the hitch coupler 201 are captured. Then, when the passenger touches the positions at which the hitch ball 16 and the hitch coupler 201 are displayed respectively, the respective touch operations are detected by the operation input unit 9, and the first acquisition unit 101 acquires the respective detected touch operations as an input to specify the hitch ball 16 and an input to specify the hitch coupler 201.

In addition, the first acquisition unit 101 acquires a sensor value of the steering angle sensor 19, a sensor value of the shift sensor 21, and a sensor value of the wheel speed sensor 22.

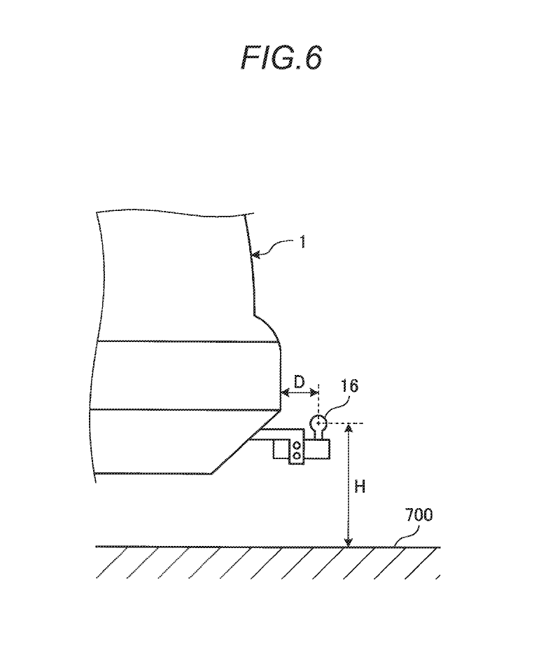

The second acquisition unit 102 acquires height information of the hitch ball 16. The height information of the hitch ball 16 indicates, for example, a distance H from the ground 700 to the center of a ball portion of the hitch ball 16, as illustrated in FIG. 6. The height information of the hitch ball 16 is used as a substitute for height information of the hitch coupler 201 in calculating a path for guidance of the vehicle 1. This is because it is assumed that the hitch ball 16 and the hitch coupler 201 are located at approximately the same height.

In addition, a method of acquiring the height information of the hitch ball 16 is not limited to a specific method. Here, the height information of the hitch ball 16 is acquired as follows, for example. The display controller 104 displays, on the display screen 8, a setting screen so as to prompt input of the height information of the hitch ball 16. The passenger inputs the height information of the hitch ball 16 by performing a touch operation on the setting screen. The second acquisition unit 102 acquires the input height information of the hitch ball 16. Here, the display timing of the setting screen is not limited to a specific timing. The setting screen may be called at any timing.

The guidance controller 103 calculates the path of the vehicle 1 until the vehicle reaches the position at which the hitch ball 16 and the hitch coupler 201 may be connected to each other based on various types of information acquired by the first acquisition unit 101 and the second acquisition unit 102. A calculation algorithm of the path of the vehicle 1 will be described later.

In the rear view mode, the display controller 104 displays a rear image from the camera 15a in which the hitch ball 16 and the hitch coupler 201 are captured on the display screen 8. In addition, in the rear view mode, the display controller 104 generates, based on the rear image, a local bird's-eye view image, which is a bird's-eye view image in which the images of the hitch ball 16 and the periphery of the hitch ball 16 are captured, and displays the generated local bird's-eye view image on the display screen 8. A generation algorithm of the local bird's eye view image will be described later.

In the rear view mode, the display controller 104 displays the rear image on the display screen 8 when the distance between the hitch ball 16 and the hitch coupler 201 is equal to or greater than a predetermined threshold value Dth1, and displays the local bird's-eye view image when the distance between the hitch ball 16 and the hitch coupler 201 is smaller than the value Dth1.

Hereinafter, of the rear view mode, a mode in which the rear image is displayed will be referred to as a “first rear view mode.” In addition, of the rear view mode, a mode in which the local bird's-eye view image is displayed will be referred to as a “second rear view mode.”

In addition, in the rear view mode, the display controller 104 may display both the rear image and the local bird's-eye view image. When displaying both the rear image and the local bird's-eye view image, the display controller 104 provides plural display areas on the display screen 8 so as to display the rear image in one display area and display the local bird's-eye view image in another display area.

In addition, in the rear view mode, the display controller 104 may always display the rear image without displaying the local bird's-eye view image. In addition, the condition for display switching between the rear image and the local bird's-eye view image is not limited to only the condition related to the distance between the hitch ball 16 and the hitch coupler 201.

The display controller 104 further displays identification information at each of the display positions of the hitch ball 16 and the hitch coupler 201. The shape of each piece of identification information is not limited to a specific shape. Here, as an example, it is assumed that each piece of identification information takes the form of a cross hair. In addition, the display controller 104 causes the cross hair to follow the display position of the hitch coupler 201, which varies depending on the movement of the vehicle 1.

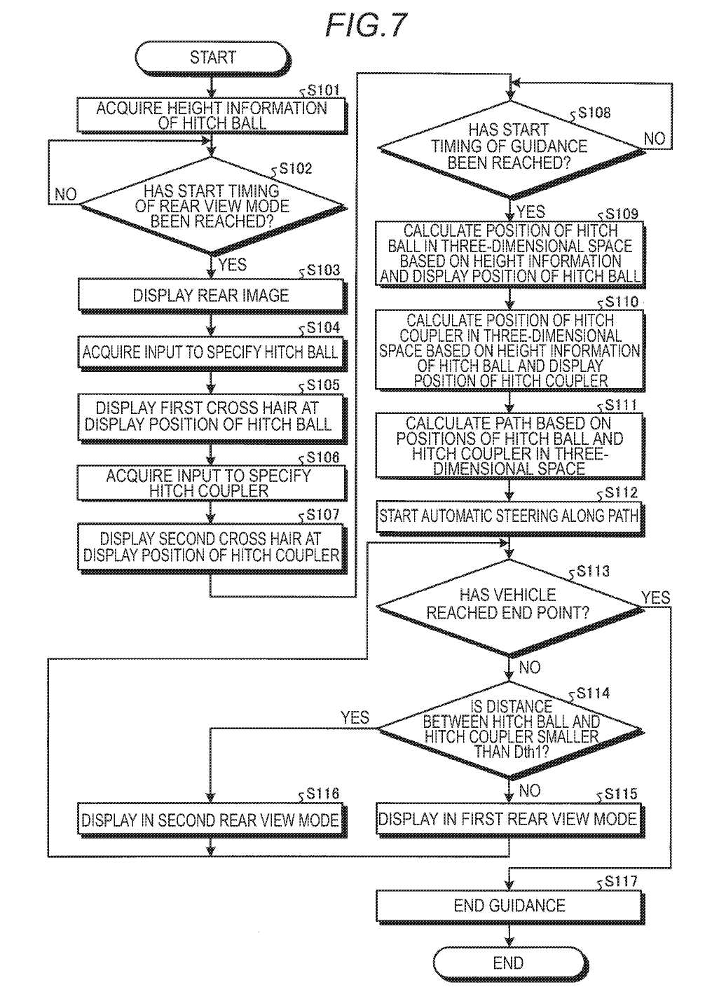

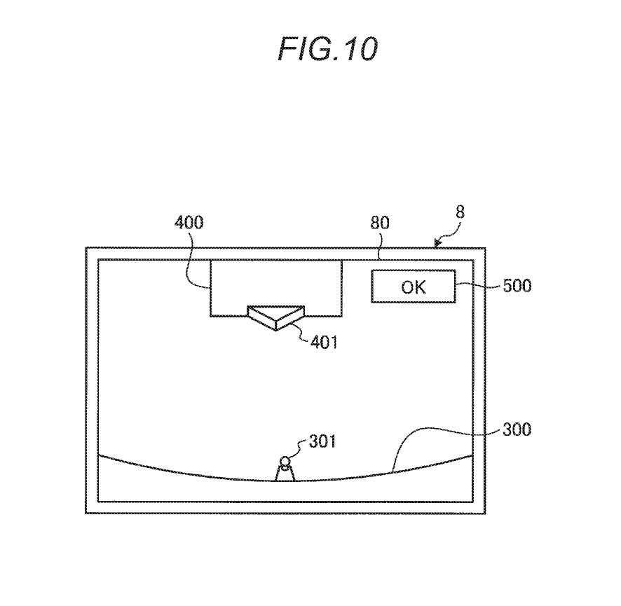

FIGS. 7 to 9 are flowcharts for explaining an operation of the ECU 14 as the periphery monitoring device of the first embodiment. In addition, FIGS. 10 to 14 are views illustrating display examples of the display screen 8 by the ECU 14 as the periphery monitoring device of the first embodiment.

First, the second acquisition unit 102 acquires the height information of the hitch ball 16 (S101). Here, as described above, the height information of the hitch ball 16 may be acquired at any timing.

Subsequently, the display controller 104 determines whether or not the start timing of the rear view mode has been reached (S102). The method of determining the start timing of the rear view mode is not limited to a specific method. In one example, the display controller 104 sequentially acquires sensor values from the shift sensor 21 via the first acquisition unit 101 so as to monitor the position of the speed-change operation unit 7. The display controller 104 determines that the start timing of the rear view mode has not been reached when the speed-change operation unit 7 is located at a position other than the reverse range, but determines that the start timing of the rear view mode has been reached when the position of the speed-change operation unit 7 shifts from any other range to the reverse range.

When it is determined that the start timing of the rear view mode has not been reached (No in S102), the display controller 104 executes again the determination processing of S102. When it is determined that the start timing of the rear view mode has been reached (Yes in S102), the display controller 104 acquires a rear image from the camera 15a via the first acquisition unit 101, and displays the acquired rear image on the display screen 8 (S103). That is, the display controller 104 starts an operation in the rear view mode. The display controller 104 sequentially outputs rear images, which are sequentially output at a predetermined frame rate, to the display screen 8.

When the rear view mode starts, as illustrated in FIG. 10, the rear image is displayed in a display area 80 of the display screen 8. In the example of FIG. 10, the rear image displayed in the display area 80 includes an image 300 representing the rear bumper of the vehicle 1, an image 301 representing the hitch ball 16, an image 400 representing the trailer 200, and an image 401 representing the hitch coupler 201. In addition, an “OK” button 500 is displayed at the right upper side of the display area 80. The “OK” button 500 will be described later.

In addition, the display controller 104 may not necessarily display the rear image from the camera 15a on the display screen 8 as it is. The display controller 104 may execute any processing on the rear image from the camera 15a, and may then display the rear image on the display screen 8. The processing includes, for example, synthesis, clipping, filtering, and superposition of any information.

Subsequently, the first acquisition unit 101 acquires an input to specify the hitch ball 16 (exactly, an input to specify the display position of the hitch ball 16) (S104). Thereby, the display controller 104 superimposedly displays a cross hair (a first cross hair 501) at the display position of the hitch ball 16 on the display screen 8 (S105).

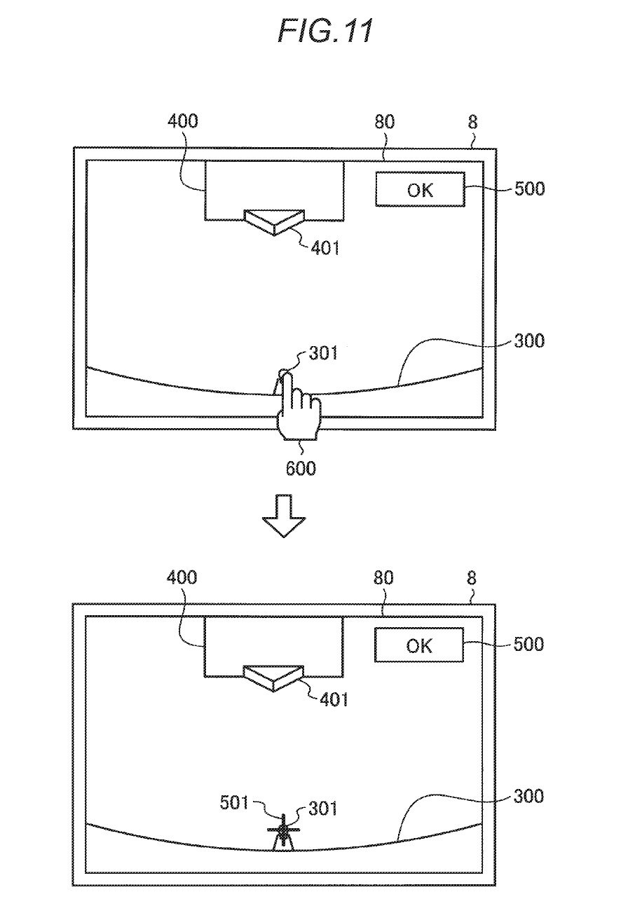

The input to specify the hitch ball 16 is input by, for example, a touch operation as described above. As illustrated in the upper part of FIG. 11, when the image 301 representing the hitch ball 16 is touched by a passenger's finger 600, the touched position is acquired as the input to specify the hitch ball 16. Then, as illustrated in the lower part of FIG. 11, the display controller 104 superimposedly displays the first cross hair 501 at the touched position. The first cross hair 501 may be displayed as a line of a type other than a solid line, such as, for example, a dotted line, or may be colored and displayed in any color.

Subsequently, the first acquisition unit 101 acquires an input to specify the hitch coupler 201 (exactly, an input to specify the display position of the hitch coupler 201) (S106). Thereby, the display controller 104 superimposedly displays a cross hair (a second cross hair 502) at the display position of the hitch coupler 201 on the display screen 8 (S107).

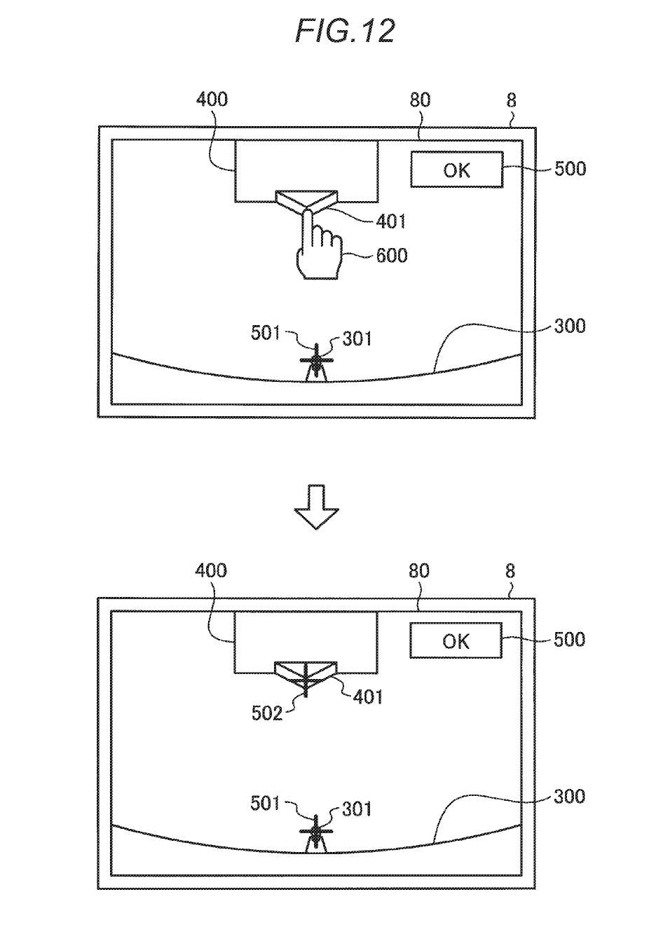

The input to specify the hitch coupler 201 is input by, for example, a touch operation as described above. As illustrated in the upper part of FIG. 12, when the image 401 representing the hitch coupler 201 is touched by the finger 600, the touched position is acquired as the input to specify the hitch coupler 201. Then, as illustrated in the lower part of FIG. 12, the display controller 104 superimposedly displays the second cross hair 502 at the touched position. The second cross hair 502 may be displayed as a line of a type other than a solid line, such as, for example, a dotted line, or may be colored and displayed in any color.

In addition, the order of the processing of S104 and the processing of S106 is not limited to the above description. The processing of S106 may be executed before the processing of S104.

In addition, in the processings of S104 and S106, the first acquisition unit 101 may receive an operation input so as to enlarge or reduce the display content of the display screen 8, and the display controller 104 may enlarge or reduce the image in response to the received operation input and display the image on the display screen 8. For example, when the operation input unit 9 receives a pinch-out input, the first acquisition unit 101 acquires the input as an operation input to enlarge an image. “Pinch-out” is an operation of touching the operation input unit 9 with two fingers and sliding the two fingers in a manner of spacing the two fingers apart from each other. The display controller 104 enlarges the image that is being displayed about just the middle portion between the two fingers. In addition, when the operation input unit 9 receives a pinch-in input, the first acquisition unit 101 acquires the input as an operation input to reduce an image. “Pinch-in” is an operation of touching the operation input unit 9 with two fingers and sliding the two fingers in a manner of picking up an object with the two fingers. The display controller 104 reduces the image that is being displayed about just the middle portion between the two fingers. In this manner, since the display content of the display screen 8 may be enlarged or reduced in response to the operation input by the passenger, the passenger may enlarge and touch the image during the processings of S104 and S106. Therefore, the passenger may more accurately touch the positions at which the images of the hitch ball 16 and the hitch coupler 201 are captured.

Subsequently, the guidance controller 103 determines whether or not the guidance start timing has been reached (S108). When it is determined that the guidance start timing has not been reached (No in S108), the processing of S108 is executed again. When it is determined that the guidance start timing has been reached (Yes in S108), the guidance controller 103 starts automatic guidance.

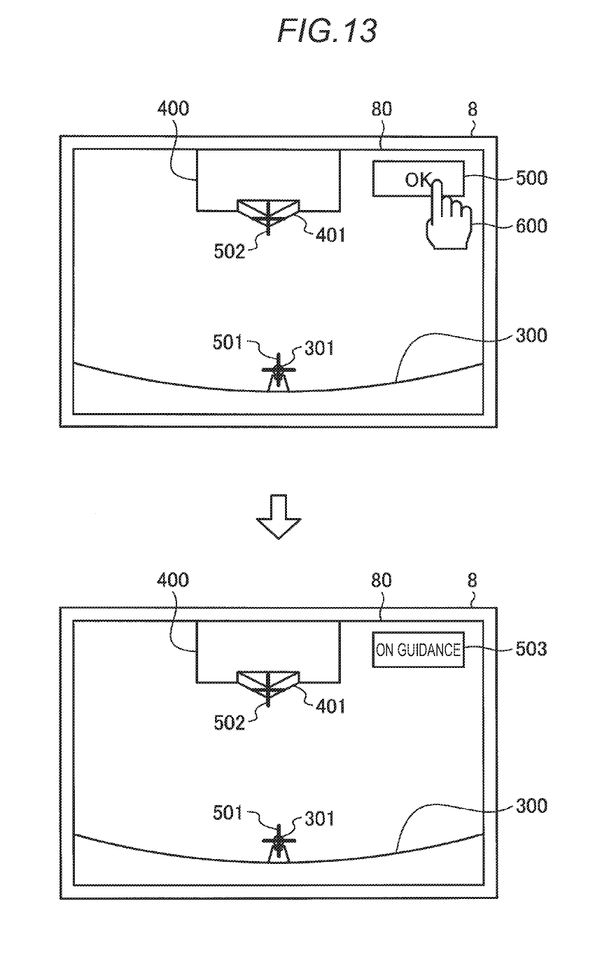

The method of determining the guidance start timing is not limited to a specific method. Here, as an example, as illustrated in the upper part of FIG. 13, when the “OK” button 500 is touched by the finger 600, this input to touch the “OK” button 500 is acquired as a setting completion notification of automatic guidance. When acquiring the setting completion notification of automatic guidance, the guidance controller 103 determines that the guidance start timing has been reached. When the automatic guidance starts, as illustrated in the lower part of FIG. 13, the display controller 104 displays, for example, identification information 503 indicating that the automatic guidance is being executed.

When the automatic guidance starts, the guidance controller 103 calculates a path. Specifically, first, the guidance controller 103 calculates the position of the hitch ball 16 in the three-dimensional space (S109). The origin of the three-dimensional space is not limited to a specific position. In addition, the coordinate system of the three-dimensional space is not limited to a specific coordinate system.

FIG. 15 is a view for explaining an example of a method of specifying a position in a three-dimensional space. In FIG. 15, a frame 150 corresponds to the frame of a rear image. In a captured image acquired by the camera 15a, a target, which is present at each position on a straight line 701, which interconnects a point 702 on the ground 700 and the camera 15a, is superimposed and displayed on one point 151 on the captured image. However, when height information Hi of a certain position 703 on the straight line 701 from the ground 700 is already known, the coordinates of the position 703 in the three-dimensional space are uniquely determined. That is, a position in the three-dimensional space is obtained from the height information and the display position in the rear image. Based on such a relationship, the guidance controller 103 calculates the position of the hitch ball 16 in the three-dimensional space using the display position and the height information of the hitch ball 16.

In addition, the guidance controller 103 calculates the position of the hitch coupler 201 in the three-dimensional space in the same procedure (S110). As described above, in this case, the guidance controller 103 substitutes the height information of the hitch ball 16 for the height information of the hitch coupler 201.

Subsequently, based on the positional relationship between the hitch ball 16 and the hitch coupler 201 in the three-dimensional space, the guidance controller 103 calculates the path of the vehicle 1 from the current position until the vehicle 1 reaches the position at which the hitch ball 16 and the hitch coupler 201 may be connected to each other, that is, the position at which the hitch ball 16 exists immediately below the hitch coupler 201 (S111).

The method of calculating the path from the current position to the position at which the hitch ball 16 and the hitch coupler 201 may be connected to each other is not limited to a specific method. In one example, the guidance controller 103 calculates the foot of a perpendicular that extends from the current position of the hitch ball 16 to the ground 700 and the foot of a perpendicular that extends from the hitch coupler 201 to the ground 700. That is, the guidance controller 103 calculates a horizontal positional relationship between the hitch ball 16 and the hitch coupler 201. The guidance controller 103 calculates the path of the hitch ball 16 by setting the foot of the perpendicular that extends from the current position of the hitch ball 16 to the ground to a beginning point and setting the foot of the perpendicular that extends from the hitch coupler 201 to the ground to an end point. Then, the guidance controller 103 converts the path of the hitch ball 16 into the path of the vehicle 1.

In addition, the horizontal positional relationship is not limited to the positional relationship between the feet of the perpendiculars that extend to the ground 700. For example, the horizontal positional relationship may be a positional relationship between the feet of the perpendiculars that extend to any horizontal plane other than the ground 700, such as the horizontal plane at the height of the hitch coupler 201 or the hitch ball 16.

Subsequently, the guidance controller 103 executes automatic steering such that the vehicle 1 moves along the calculated path (S112). The guidance controller 103 determines a steering angle such that that the vehicle 1 moves along the calculated path, and instructs the steering system 13 to steer the wheels 3 to the determined steering angle. The passenger may move the vehicle 1 along the path by merely operating the acceleration operation unit 5 and the braking operation unit 6. In addition, the guidance controller 103 may automatically control acceleration and deceleration as well as steering.

After the guidance starts, the ECU 14 repeatedly executes the loop processing from S113 to S115 or S116 until it is determined that the vehicle 1 has reached the end point of the path (Yes in S113). The execution timing of the loop processing may be arbitrarily designed. The loop processing may be executed at a predetermined time interval, for example, every 0.1 seconds or whenever one frame of the rear image is acquired, or may be executed whenever the vehicle 1 moves by a predetermined distance such as, for example, 0.05 m.

In the loop processing, first, the guidance controller 103 determines whether or not the vehicle 1 has reached the end point of the path (S113). Specifically, the guidance controller 103 estimates the current position of the vehicle 1. Then, the guidance controller 103 determines whether or not the estimated current position coincides with the end point of the path.

The method for estimating the current position of the vehicle 1 is not limited to a specific method. In one example, the guidance controller 103 acquires a sensor value of the wheel speed sensor 22 via the first acquisition unit 101, and estimates the current position by wheel odometry using the acquired sensor value. In another example, the guidance controller 103 specifies the current position using a global positioning system (GPS) (not illustrated). In a further example, the guidance controller 103 creates an optical flow using sequentially acquired rear images and estimates the current position based on the created optical flow.

When it is determined that the vehicle 1 has not reached the end point of the path (No in S113), the display controller 104 determines whether or not the distance between the hitch ball 16 and the hitch coupler 201 is smaller than the value Dth1 (S114).

When it is determined that the distance between the hitch ball 16 and the hitch coupler 201 is not smaller than the value Dth1 (No in S114), the display controller 104 executes display in the first rear view mode (S115).

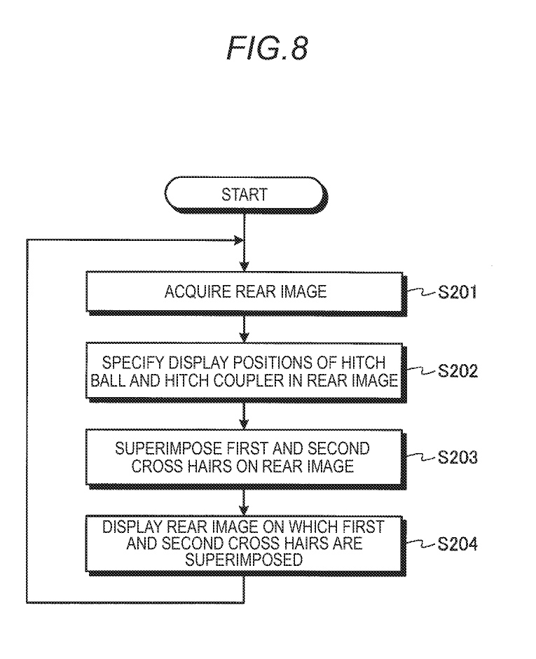

In the first rear view mode, as illustrated in FIG. 8, the first acquisition unit 101 firstly acquires a rear image (S201). The display controller 104 specifies each of the display positions of the hitch ball 16 and the hitch coupler 201 in the rear image (S202).

A positional relationship between the camera 15a and the hitch ball 16 is fixed. Therefore, the display controller 104 may set the position specified by the processing of S104 to the display position of the hitch ball 16.

Any method may be employed as a method of specifying the display position of the hitch coupler 201. In one example, the display controller 104 stores an image in a unit area about the position specified by the processing of S106. The unit area is an area smaller than the rear image and has a fixed size. The display controller 104 sequentially sets the unit area while changing the position thereof in the current rear image and compares an image in each set unit area with a stored image, thereby searching for the unit area that is most similar to the stored image. Determination of similarity/dissimilarity is made, for example, by comparing feature quantities. The display controller 104 determines the center of the searched unit area as the display position of the hitch coupler 201 in the current rear image. After determining the display position of the hitch coupler 201, the display controller 104 may overwrite the stored image in the unit area with the image in the unit area about the determined display position.

In another example, the display controller 104 calculates a positional relationship between the camera 15a and the hitch coupler 201 in the three-dimensional space based on the current position of the vehicle 1 estimated by the guidance controller 103, and specifies the display position of the hitch coupler 201 based on the positional relationship obtained by the calculation. The positional relationship between the camera 15a and the hitch coupler 201 in the three-dimensional space may be calculated by any method such as, for example, the wheel odometry, a processing of signals from a GPS or an image processing.

Subsequently, the display controller 104 superimposes the first cross hair 501 and the second cross hair 502 on the rear image (S203). That is, the display controller 104 superimposes the first cross hair 501 on the specified display position of the hitch ball 16, and superimposes the second cross hair 502 on the specified display position of the hitch coupler 201.

Subsequently, the display controller 104 displays the rear image on which the first cross hair 501 and the second crosshair 502 are superimposed on the display screen 8 (S204). Then, the control is transferred to the processing of S201.

In the first rear view mode, as the loop processing of S201 to S204 is repeatedly executed, the display position of the second cross hair 502 is sequentially updated so as to follow the movement of the display position of the hitch coupler 201.

Returning to FIG. 7, when it is determined that the distance between the hitch ball 16 and the hitch coupler 201 is smaller than the value Dth1 (Yes in S114), the display controller 104 executes display in the second rear view mode (S116).

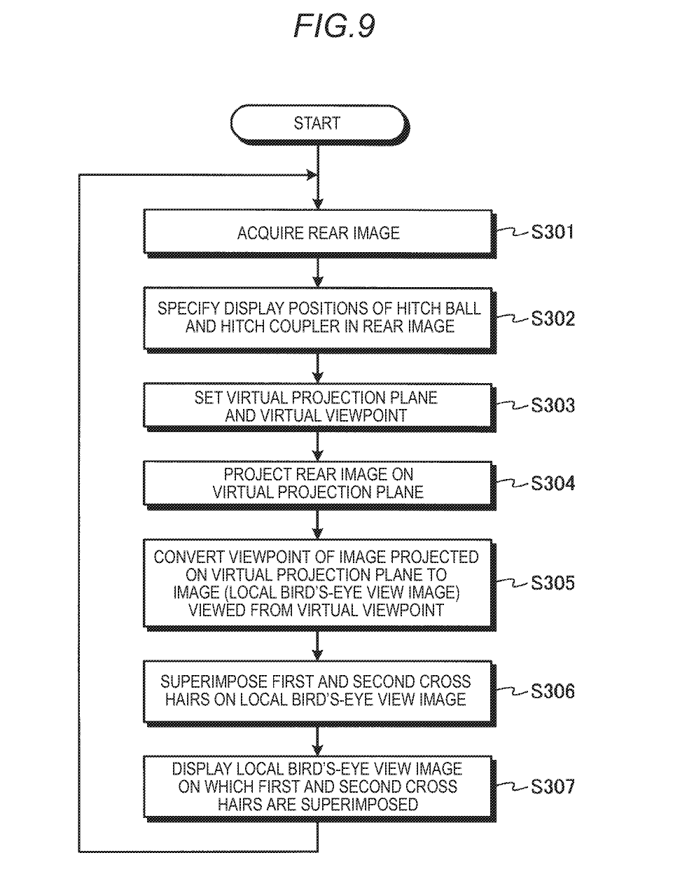

In the second rear view mode, as illustrated in FIG. 9, the first acquisition unit 101 firstly acquires a rear image (S301). The display controller 104 specifies the display positions of the hitch ball 16 and the hitch coupler 201 in the rear image in the same procedure as in S202 (S302). The display controller 104 stores each specified position.

Subsequently, the display controller 104 sets a virtual projection plane and a virtual viewpoint (S303).

The virtual projection plane is a plane parallel to the ground 700, that is, a horizontal plane, and the height of the virtual projection plane from the ground 700 is equal to the height of the hitch coupler 201. In addition, the height of the virtual projection plane may not need to be exactly the same as the height of the hitch coupler 201 and may be approximately the same as the height of the hitch coupler 201. That is, the height of the virtual projection plane corresponds to the height of the hitch coupler 201. For example, the display controller 104 sets the height information of the hitch ball 16 to the height of the virtual projection plane. The virtual viewpoint is located behind the vehicle 1 and is fixed at a relative position with respect to the vehicle 1. For example, the virtual viewpoint is located immediately above the hitch ball 16, and the optical axis of the virtual viewpoint is fixed downward.

Subsequently, the display controller 104 projects the rear image onto the virtual projection plane (S304). Then, the display controller 104 converts the image projected on the virtual projection plane into an image seen from the virtual viewpoint (S305). The display controller 104 obtains a local bird's-eye view image by the processing of S305.

The display controller 104 superimposes the first cross hair 501 and the second cross hair 502 on the local bird's-eye view image (S306). That is, the display controller 104 superimposes the first cross hair 501 on the display position of the hitch ball 16 and superimposes the second cross hair 502 on the display position of the hitch coupler 201.

The display controller 104 executes the calculations of S303 and S304 with respect to the display positions of the hitch ball 16 and the hitch coupler 201 specified by the processing of S302, thereby obtaining the display position of the hitch ball 16 and the display position of the hitch coupler 201 in the local bird's-eye view image. Here, a method of specifying the display positions of the hitch ball 16 and the hitch coupler 201 in the local bird's-eye view image is not limited thereto.

Subsequently, the display controller 104 displays the local bird's-eye view image, on which the first cross hair 501 and the second cross hair 502 are superimposed, on the display screen 8 (S307). Then, the control is transferred to the processing of S301.

In the second rear view mode, as the loop processing of S301 to S307 is repeatedly executed, the display position of the second crosshair 502 is sequentially updated so as to follow the movement of the display position of the hitch coupler 201.

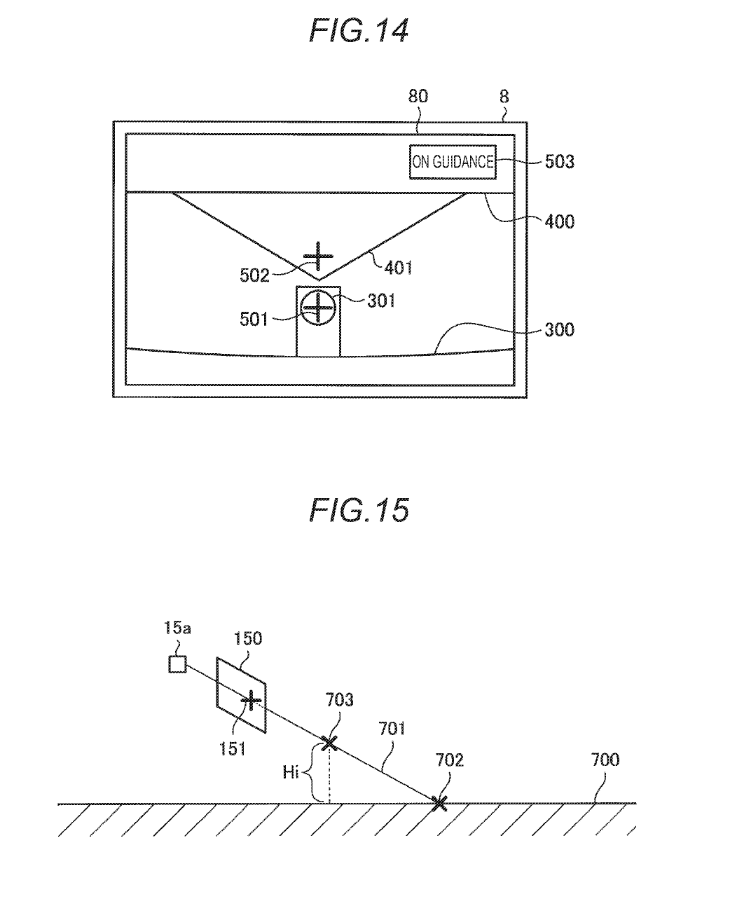

As illustrated in FIG. 14, in the second rear view mode, a local bird's-eye view image of the hitch ball 16 viewed from directly above is displayed in the display area 80 of the display screen 8. When the local bird's-eye view image is generated by viewpoint conversion after the rear image is projected onto the virtual ground 700, the movement speed of the vehicle 1 corresponds to the movement speed of the ground 700 in the local bird's-eye view image. However, since the hitch ball 16 and the hitch coupler 201 are positionally interposed between the camera 15a and the ground 700, the movement speed of the display position of the hitch coupler 201 with respect to the movement speed of the vehicle 1 is high, and as a result, the passenger may likely to feel discomfort in the displayed content. In addition, since the movement speed of the display position of the hitch coupler 201 relative to the movement speed of the vehicle 1 is increased, when the passenger moves the vehicle 1 backward while checking the distance between the connection devices via the display screen 8, the passenger may cause, for example, the operation delay of the braking operation unit 6 as a brake pedal. In the first exemplary embodiment, the virtual projection plane is set to a height that corresponds to the height of the hitch coupler 201, and the local bird's-eye view image is generated from the rear image projected on the virtual projection plane. Therefore, the movement speed of the display position of the hitch coupler 201 corresponds to the movement speed of the vehicle 1. Therefore, the problem in which the passenger feels uncomfortable is solved, and the possibility that the passenger will cause the operation delay of the braking operation unit 6 is reduced. That is, the passenger may more easily align the hitch ball 16 and the hitch coupler 201 with each other.

Returning back to FIG. 7, in the determination processing of S113, when it is determined that the vehicle 1 has reached the end point of the path (Yes in S113), the ECU 14 terminates the guidance of the vehicle 1 (S117), and the operation as the periphery monitoring device in the first embodiment is terminated.

In addition, in the above description, although the display controller 104 has been described as executing display in the first rear view mode when the distance between the hitch ball 16 and the hitch coupler 201 is equal to or greater than the value Dth1, a processing in the case where the distance between the hitch ball 16 and the hitch coupler 201 is equal to the value Dth1 is not limited thereto. When the distance between the hitch ball 16 and the hitch coupler 201 is equal to the value Dth1, the display controller 104 may execute display in the second rear view mode.

In addition, the height information of the hitch coupler 201 has been described above as being substituted by the height information of the hitch ball 16. The height information of the hitch coupler 201 may be input separately from the height information of the hitch ball 16. For example, the display controller 104 may prompt an input of the height information of the hitch coupler 201, and the second acquisition unit 102 may acquire the height information of the hitch coupler 201.

As described above, in the first exemplary embodiment, the first acquisition unit 101 acquires the rear image in which the hitch ball 16 and the hitch coupler 201 are captured from the camera 15a. The second acquisition unit 102 acquires the height information of the hitch coupler 201. The guidance controller 103 calculates a positional relationship between the hitch ball 16 and the hitch coupler 201 based on the display position of the hitch coupler 201 in the rear image and the height information of the hitch coupler 201, and calculates the path of the vehicle 1 until the hitch ball 16 and the hitch coupler 201 are connected to each other based on the calculated positional relationship, thereby guiding the vehicle 1 along the path.

Thus, since the ECU 14 as the periphery monitoring device may automatically guide the vehicle 1 in the connecting operation, the connecting operation between the vehicle 1 and the trailer 200 may be easily performed.

In addition, in the first exemplary embodiment, when the distance between the hitch ball 16 and the hitch coupler 201 is equal to or greater than the predetermined value Dth1, the display controller 104 displays the rear image on the display screen 8. In addition, when the distance between the hitch ball 16 and the hitch coupler 201 is smaller than the predetermined value Dth1, the display controller 104 projects the rear image onto the virtual projection plane, which is a horizontal plane corresponding to the height information of the hitch coupler 201, generates a local bird's-eye view image of the rear image projected on the virtual projection plane viewed from above the vehicle 1, and displays the local bird's-eye view image on the display screen 8.

Thus, since the ECU 14 as the periphery monitoring device displays the hitch coupler 201 so that the movement speed of the display position of the hitch coupler 201 more accurately corresponds to the movement speed of the vehicle 1 during the automatic guidance, the passenger may more easily perform position alignment between the hitch ball 16 and the hitch coupler 201.

In addition, when the distance between the hitch ball 16 and the hitch coupler 201 is equal to the predetermined value Dth1, the display controller 104 may execute any processing. When the distance between the hitch ball 16 and the hitch coupler 201 is equal to the predetermined value Dth1, the display controller 104 may display the rear image on the display screen 8, or may generate and display a local bird's-eye view image on the display screen 8.

In addition, in the first embodiment, the first acquisition unit 101 acquires an input so as to specify the display position of the hitch coupler 201 via the operation input unit 9. Therefore, the ECU 14 as the periphery monitoring device may specify the display position of the hitch coupler 201 with a simple algorithm.

In addition, the ECU 14 as the periphery monitoring device may specify the display position of the hitch coupler 201 by a method other than a method in which the first acquisition unit 101 acquires an input to specify the display position of the hitch coupler 201 from the operation input unit 9. In one example, the guidance controller 103 specifies the display position of the hitch coupler 201 in the rear image by any image recognition processing. The image recognition processing is, for example, pattern matching. Therefore, since the display position of the hitch coupler 201 is specified without requiring a touch input to the display screen 8 by the passenger, the operation burden of the passenger is reduced.

In addition, in the first embodiment, the second acquisition unit 102 acquires the height information of the hitch coupler 201 via the operation input unit 9. Therefore, the ECU 14 as the periphery monitoring device may acquire the height information of the hitch coupler 201 with a simple algorithm.

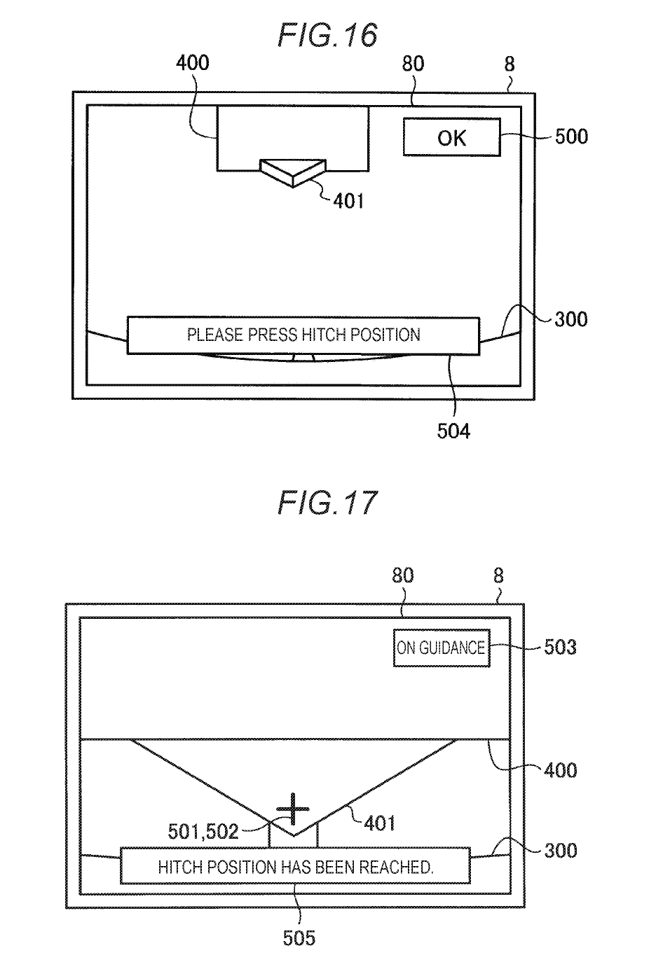

In addition, the display controller 104 may display identification information, which prompts an input, on the display screen 8 in the processing of S104 or S106. For example, in the processing of S 106, as illustrated in FIG. 16, the display controller 104 may display, in the display area 80, text information 504 described as “Please press the hitch position” as the identification information that hurries an input. Therefore, the ECU 14 as the periphery monitoring device may easily indicate to the passenger what kind of input should be made.

In addition, when it is determined that the vehicle 1 has reached the end point of the path (Yes in S113), the display controller 104 may display identification information indicating that the vehicle 1 has reached the end point of the path on the display screen 8. For example, in the processing of S117, as illustrated in FIG. 17, the display controller 104 may display, in the display area 80, text information 505 described as “The hitch position has been reached” as the identification information indicating that the vehicle 1 has reached the end point of the path. Therefore, the ECU 14 as the periphery monitoring device may indicate to the passenger that the hitch ball 16 and the hitch coupler 201 may be connected to each other in an easy-to-understand manner. In addition, the method of notifying that the vehicle 1 has reached the end point of the path is not limited thereto. For example, in order to indicate that the vehicle 1 has reached the end point of the path in the processing of S117, the display controller 104 may change the display form (e.g., the color, thickness, line type, or size) of the first cross hair 501 or the second cross hair 502.

In addition, in the case where the guidance controller 103 specifies the display position of the hitch coupler 201 using the image recognition processing, the display controller 104 may change the display content of the display screen 8 at the timing at which the display position of the hitch coupler 201 is successfully specified.

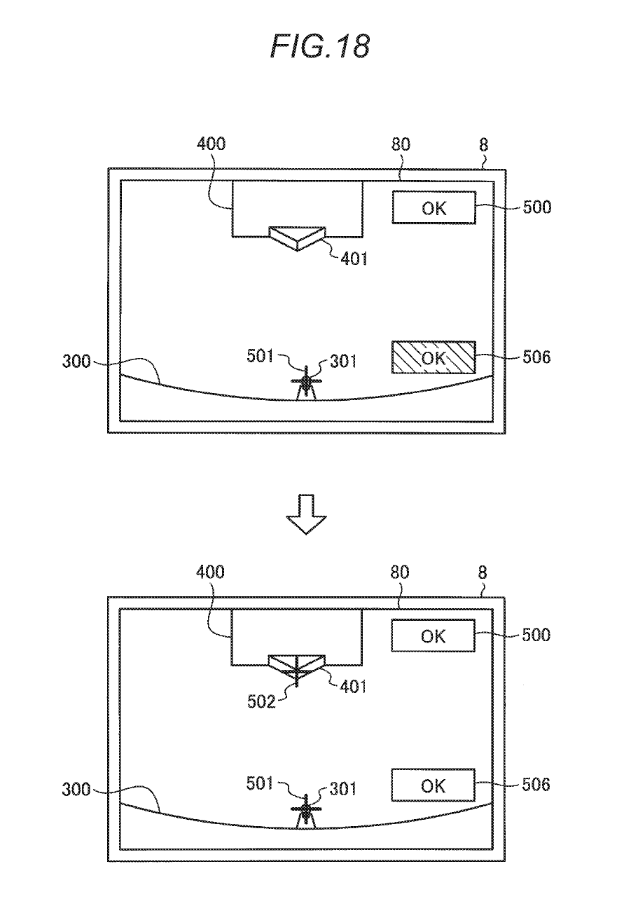

For example, as illustrated in FIG. 18, while the image recognition processing is executed, the display controller 104 displays a second “OK” button 506 in a form colored in a dark color such as, for example, gray. In addition, when the display position of the hitch coupler 201 is specified by the image recognition processing, the display controller 104 displays the second cross hair 502 at a specified position, and also displays the second “OK” button 506 in a form colored in a bright color such as, for example, yellow or white. When the second “OK” button 506 is colored and displayed in a dark color, a touch input to the second “OK” button 506 is not received. When the second “OK” button 506 is colored and displayed with a bright color, a touch input to the second OK button 506 is received. The passenger determines whether or not the second cross hair 502 is displayed at the display position of the hitch coupler 201. When it is determined that the second cross hair 502 is displayed at the display position of the hitch coupler 201, the passenger touches the second “OK” button 506, which is colored and displayed with a bright color. Then, the processing of specifying the display position of the hitch coupler 201 is completed. When it is determined that the second cross hair 502 is not displayed at the display position of the hitch coupler 201, the passenger may input the correct display position of the hitch coupler 201 by a touch operation without touching the second “OK” button 506.

In addition, when it is possible to capture the display position of the hitch coupler 201 by the image recognition processing, the display controller 104 may superimposedly display a frame surrounding the display position of the hitch coupler 201, and when it is not possible to capture the display position of the hitch coupler 201 by the image recognition processing, the display controller 104 may not display the frame. The shape of the frame is not limited to a specific shape. For example, the frame may have a circular, diamond, square, or rectangular shape.

In addition, the image recognition processing may be executed when the vehicle 1 stops, or may be executed while the vehicle 1 is moving.

In addition, when specifying the display position of the hitch coupler 201 in the rear image by the image recognition processing, the guidance controller 103 may narrow the search area of the display position based on predetermined information.

In one example, the guidance controller 103 calculates an expected trajectory in a case where the vehicle 1 moves backward at the current steering angle based on a sensor value of the steering angle sensor 19. Then, the guidance controller 103 superimposes the expected trajectory on the rear image after viewpoint conversion, and preferentially searches for the area of the rear image on the expected trajectory. Therefore, when the passenger operates the steering unit 4 so that the vehicle 1 may move backward toward the hitch coupler 201, the display position of the hitch coupler 201 may be efficiently specified by searching for the expected trajectory of the vehicle 1.

In another example, the guidance controller 103 acquires an input of a touch operation to specify the display position of the hitch coupler 201 via the first acquisition unit 101, and preferentially searches for the periphery of a touched portion in the rear image.

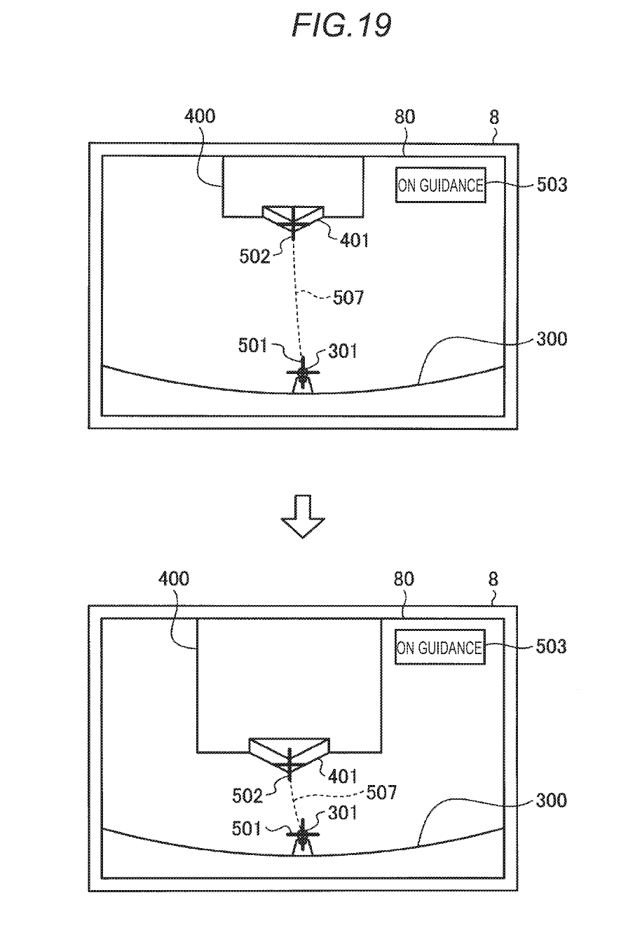

In addition, the display controller 104 may display a linear image 507, which interconnects the first cross hair 501 and the second cross hair 502, as illustrated in the upper part of FIG. 19. The shape of the image 507 may be a straight line, or may be a curved line as illustrated in FIG. 19. The shape of the image 507 may have a shape corresponding to the path calculated by the guidance controller 103. In addition, the display form (e.g., color, thickness, or line type) of the image 507 may be arbitrarily designed. When the display position of the hitch coupler 201 is moved on the display screen 8 due to the movement of the vehicle 1, the display controller 104 changes the shape of the line 507 depending on the movement of the display position of the hitch coupler 201 on the display screen 8, as illustrated in the lower part of FIG. 19. Therefore, the passenger may intuitively grasp a positional relationship between the hitch ball 16 and the hitch coupler 201 from, for example, the inclination angle or the length of the image 507.

In addition, prior to starting the automatic guidance, the guidance controller 103 may calculate various paths, thereby allowing the passenger to select one of the calculated various paths. For example, the display controller 104 displays plural linear images 507 corresponding to respective different paths in the display area 80. The passenger may select a desired path by a touch input among the displayed images 507.

In addition, the display controller 104 executes luminance manipulation or gamma correction of pixels around the display position of the first cross hair 501 or the second cross hair 502, thereby more prominently displaying the specified display position of the hitch ball 16 or the hitch coupler 201. Therefore, since the attractiveness of the display position of the hitch ball 16 or the hitch coupler 201 is improved, it is possible to suppress the occurrence of the operation delay of the braking operation unit 6.

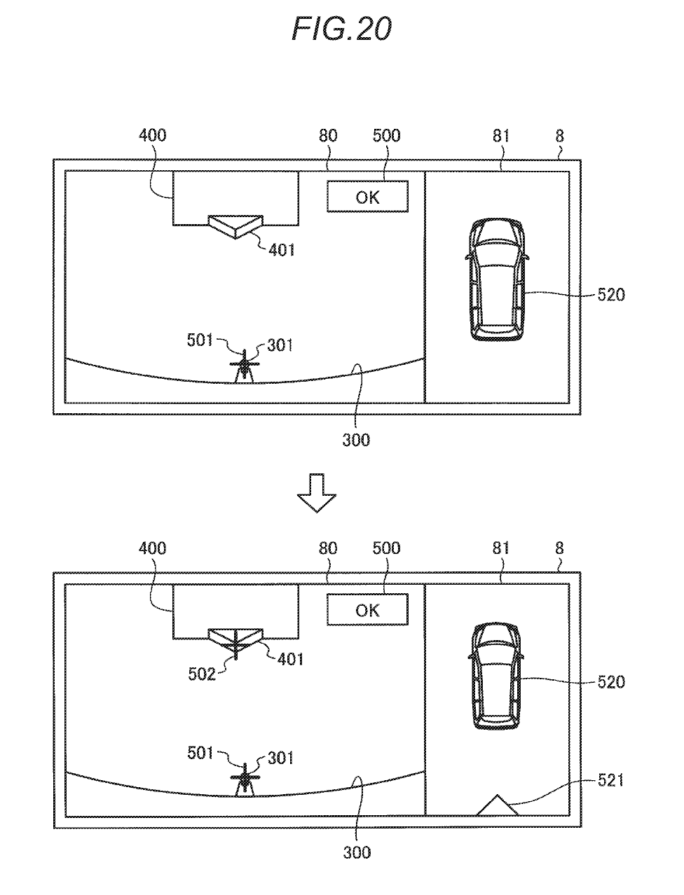

In addition, as illustrated in the upper part of FIG. 20, the display controller 104 may provide a display area 81, which is different from the display area 80, on the display screen 8, and may display, in the display area 81, a wide-area bird's-eye view image, which indicates a wider area than the local bird's-eye view image. The wide-area bird's-eye view image includes, for example, an image 520 representing the vehicle 1, and represents the surrounding environment at the front, rear, left and right sides of the vehicle 1. The image 520 representing the vehicle 1 may be an image generated from an actual image of the vehicle 1 imaged from above, or may be an illustration image schematically representing the vehicle 1. For example, the wide-area bird's-eye view image is generated by projecting four captured images acquired from the cameras 15a to 15d onto the ground 700, performing viewpoint conversion to images viewed from the virtual viewpoint provided above the vehicle 1, and then seamlessly connecting the four viewpoint-converted images.

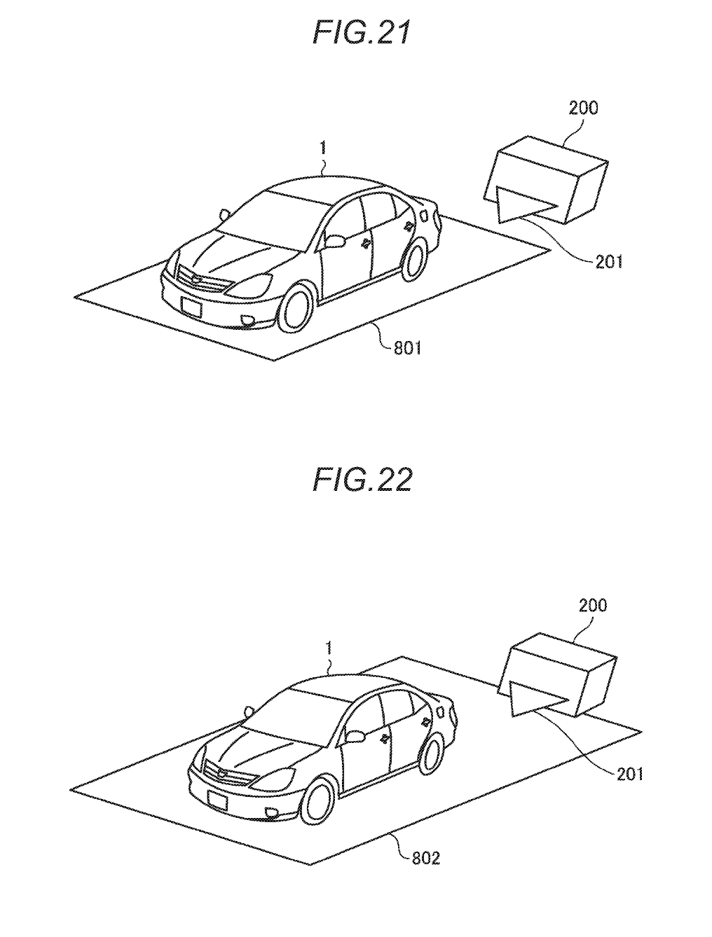

In addition, when the input to specify the hitch coupler 201 is acquired (S106), or when the display position of the hitch coupler 201 is specified by, for example, the image recognition processing, as illustrated in the lower part of FIG. 20, the display controller 104 may adjust the height of the virtual viewpoint, or may enlarge or reduce the wide area bird's-eye view image so that an image 521 representing the hitch coupler 201 is included in the wide area bird's-eye view image. For example, the wide-area bird's-eye view image illustrated in the upper part of FIG. 20 corresponds to a bird's-eye view image of an area 801 in FIG. 21 in which a positional relationship between the vehicle 1 and the trailer 200 is illustrated. In addition, the wide-area bird's-eye view image illustrated in the lower part of FIG. 20 corresponds to a bird's eye view image of an area 802 in FIG. 22 in which a positional relationship between the vehicle 1 and the trailer 200 is illustrated. Since the area indicated by the wide area bird's-eye view image is enlarged so as to include the position of the hitch coupler 201, the passenger may intuitively grasp the distance between the vehicle 1 and the hitch coupler 201 at the time when the vehicle 1 starts to move backward. Here, the image 521 showing the hitch coupler 201 may be an image generated from an actual image, or may be a display model schematically showing the hitch coupler 201.

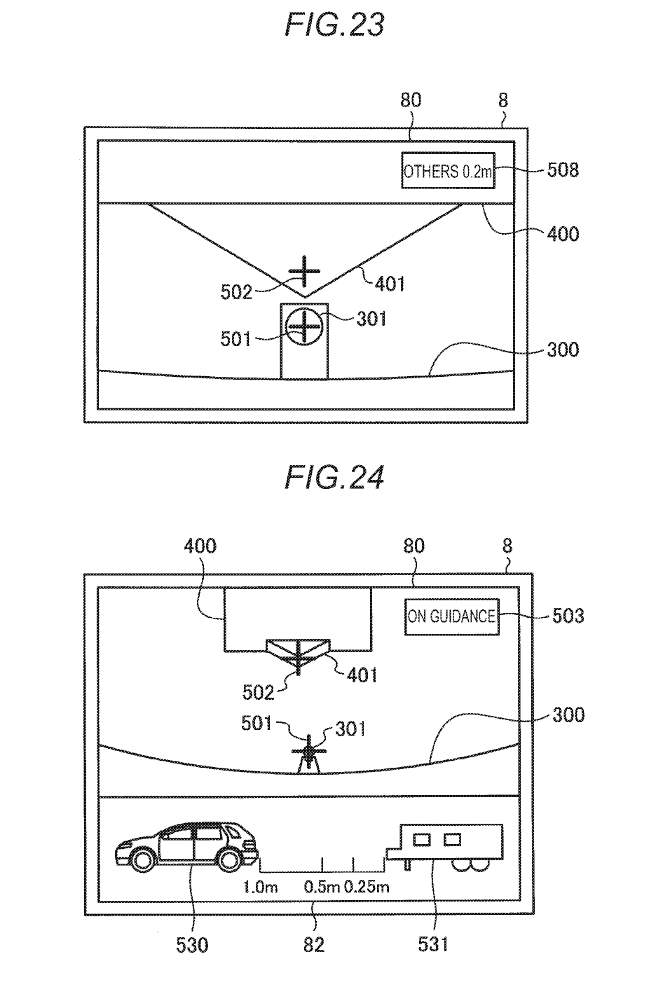

In addition, as illustrated in FIG. 23, the display controller 104 may display text information 508, which quantitatively indicates the distance between the hitch ball 16 and the hitch coupler 201. Here, FIG. 23 illustrates a display example in the second rear view mode, but the display controller 104 may display the text information 508 in the first rear view mode.

In addition, as illustrated in FIG. 24, the display controller 104 may provide, on the display screen 8, a display area 82, which is different from the display area 80, and may display, in the display area 82, an image of both the vehicle 1 and the trailer 200 viewed from the lateral side. In this example, an image 530 representing the side surface of the vehicle 1 and an image 531 representing the side surface of the trailer 200 are spaced apart from each other in the horizontal direction of the display area 82, and the distance between the display position of the image 530 and the display position of the image 531 corresponds to the distance between the vehicle 1 and the trailer 200. Therefore, the passenger may qualitatively grasp the distance between the vehicle 1 and the trailer 200 from the display content of the display area 82. In addition, in this example, the scale indicating the distance is displayed in the horizontal direction of the display area 82. Therefore, the passenger may more accurately grasp the distance between the vehicle 1 and the trailer 200 from the scale. Here, each of the image 530 and the image 531 may be generated from an actual image, or may be an illustration image.

In addition, while the automatic guidance is executed, the guidance controller 103 may detect an obstacle around the vehicle 1, and may perform the emergency stop of the vehicle 1 before the vehicle 1 collides with the detected obstacle. The obstacle is detected using, for example, captured images from the cameras 15a to 15d. Alternatively, any sensor such as, for example, a distance measurement sonar or a laser range scanner may be provided in the vehicle 1, and the obstacle may be detected using the sensor. The guidance controller 103 may obtain the movement trajectory of the vehicle body 2 from the calculated path, and may perform the emergency stop of the vehicle 1 when an obstacle is detected on the movement trajectory. The collision of the vehicle 1 with the obstacle includes an event in which the vehicle 1 involves an obstacle on the lateral side of the vehicle body 2. In addition, the guidance controller 103 may issue an alarm to the passenger or the outside of the vehicle 1 before the vehicle 1 collides with the detected obstacle. The guidance controller 103 may issue an alarm by sound to the inside of the vehicle cabin 2a or to the outside of the vehicle cabin 2a using, for example, a horn or a speaker (not illustrated), may issue an alarm by turning on or blinking various lights, or may issue an alarm by displaying predetermined contents on the display screen 8.

In addition, the guidance controller 103 may limit the upper limit speed of the vehicle 1 depending on the distance between the hitch ball 16 and the hitch coupler 201. In one example, the guidance controller 103 does not limit the speed of the vehicle 1 when the distance between the hitch ball 16 and the hitch coupler 201 is equal to or greater than a predetermined distance Dth2, and limits the upper limit speed of the vehicle 1 to a predetermined small value when the distance between the hitch ball 16 and the hitch coupler 201 is smaller than the predetermined distance Dth2. When the distance between the hitch ball 16 and the hitch coupler 201 becomes short and the hitch ball 16 and the hitch coupler 201 are aligned with each other, the vehicle 1 may be controlled so as not to have a speed higher than the predetermined value, so that the distance over which the vehicle 1 exceeds the end point of the path may be kept small even if the operation delay of the braking operation unit 6 occurs by the passenger. Therefore, alignment between the hitch ball 16 and the hitch coupler 201 is facilitated. In addition, the risk of collision between the vehicle 1 and the trailer 200 is reduced.

In addition, the second acquisition unit 102 may acquire not only the height information of the hitch ball 16, but also horizontal distance information between the hitch ball 16 and the vehicle 1. The horizontal distance information is, for example, a horizontal distance D from the rear end portion of the vehicle 1 to the hitch ball 16, as illustrated in FIG. 6. The guidance controller 103 specifies the position of the hitch ball 16 in the three-dimensional space based on the height information of the hitch ball 16 and the horizontal distance information. In addition, the display controller 104 specifies the display position of the hitch ball 16 based on the position of the hitch ball 16 in the three-dimensional space. Therefore, with respect to the hitch ball 16, an input of a touch operation to specify the display position may be unnecessary.

### Second Embodiment

In the first embodiment, the example in which the second acquisition unit 102 acquires the height information of the hitch coupler 201 by the passenger's input has been described. The second acquisition unit 102 may calculate the height information by executing a stereo image processing on a rear image, rather than acquiring the height information from the passenger's input.

That is, the second acquisition unit 102 calculates the height information of the hitch coupler 201 by acquiring plural rear images from the camera 15a via the first acquisition unit 101 and executing a stereo image processing on the plural acquired rear images.

In one example, during the movement of the vehicle 1, the second acquisition unit 102 acquires plural rear images in which the images of the hitch coupler 201 are captured at different timings. The second acquisition unit 102 specifies the display position of the hitch coupler 201 based on an input to specify the display position. The second acquisition unit 102 calculates the height information of the hitch coupler 201 by executing calculation based on a motion stereo method using plural rear images acquired at different timings. The second acquisition unit 102 acquires the amount of movement of the vehicle 1 necessary for calculation from the guidance controller 103.

In the case where a vehicle height adjustment mechanism, which enables change in vehicle height, is provided in the vehicle 1, the second acquisition unit 102 may calculate the height information of the hitch coupler 201 by raising or lowering the vehicle height, for example, while the vehicle 1 stops, acquiring plural images captured at timings at which the vehicle has different heights, and executing calculation based on a motion stereo method using the plural acquired rear images.

In the case where plural cameras 15a are provided in the vehicle 1, the second acquisition unit 102 may calculate the height information of the hitch coupler 201 by acquiring respective captured images from the plural cameras 15a and executing calculation based on a binocular stereo method using the plural captured images. In addition, a stereo camera may be applied as the camera 15a, and the height information may be acquired based on a rear image from the stereo camera.

Therefore, since it is not necessary to input the height information by the passenger, the operation burden of the passenger is reduced.

In addition, in the same manner as the first embodiment, the guidance controller 103 may specify the display position of the hitch coupler 201 using the image recognition processing. The guidance controller 103 specifies the display position of the hitch coupler 201 using the image recognition processing, and the second acquisition unit 102 acquires the specified height information of the hitch coupler 201 by the stereo image processing. Therefore, with respect to the hitch coupler 201, a touch input to specify the display position may be unnecessary. In addition, in the same manner as the first embodiment, the guidance controller 103 may narrow the search area of the display position of the hitch coupler 201 based on a sensor value of the steering angle sensor 19 or the input of a touch operation.

In addition, the ECU 14 as the periphery monitoring device may cause the passenger to start the backward movement of the vehicle 1, the second acquisition unit 102 may acquire the height information of the hitch coupler 201 by the stereo image processing while the vehicle 1 moves backward, and the guidance controller 103 may start automatic guidance when the height information is acquired.

In addition, the second acquisition unit 102 may specify the position in the three-dimensional space including the height information of the hitch coupler 201 based on the stereo image processing. In that case, the guidance controller 103 may calculate a path using the position of the hitch coupler 201 in the three-dimensional space, which is specified by the second acquisition unit 102.

In addition, in the case where a sensor such as a laser range scanner or a distance measuring sonar is provided in the vehicle 1, the second acquisition unit 102 may specify the height information of the hitch coupler 201 or the position of the hitch coupler 201 in the three-dimensional space based on a sensor value from the sensor.

In addition, in the case where a vehicle height adjustment mechanism is provided in the vehicle 1, the guidance controller 103 determines whether or not the hitch ball 16 and the hitch coupler 201 interfere with each other by comparing the height information of the hitch ball 16 with the height information of the hitch coupler 201. When it is determined that the hitch ball 16 and the hitch coupler 201 interfere with each other, the guidance controller 103 may control the vehicle height adjustment mechanism so as to lower the vehicle height so that the hitch ball 16 does not interfere with the hitch coupler 201.

Although the embodiments of the present disclosure have been exemplified above, the above-described embodiments and modifications thereof are merely given by way of example, and are not intended to limit the scope of this disclosure. The above-described embodiments and modifications may be implemented in various other modes, and various omissions, substitutions, combinations, and changes thereof may be made without departing from the gist of this disclosure. In addition, the configurations or shapes of the respective embodiments and modifications may also be partially replaced and implemented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
a first acquisition unit configured to acquire a first image in which a first connection device provided in a vehicle and a second connection device provided in a towed vehicle are captured;
a second acquisition unit configured to acquire height information of the second connection device; and
a guidance controller configured to calculate a positional relationship between the first connection device and the second connection device based on a display position of the second connection device in the first image and the height information, calculate a path of the vehicle until the first connection device and the second connection device are connected to each other based on the positional relationship, and to guide the vehicle along the path.

2. The periphery monitoring device according to claim 1, further comprising:
a display controller configured such that, when a distance between the first connection device and the second connection device is greater than a predetermined value, the display controller displays the first image on a display screen configured to be provided in an interior of a vehicle cabin, and, when the distance is smaller than the predetermined value, the display controller projects the first image on a horizontal plane having a height corresponding to the height information, generates a second image, which is an image viewing the first image projected on the horizontal plane from above the vehicle, and displays the second image on the display screen.

3. The periphery monitoring device according to claim 1,
wherein the first acquisition unit acquires an input to specify the display position of the second connection device via an operation input unit provided in the vehicle.

4. The periphery monitoring device according to claim 1,
wherein the guidance controller specifies the display position of the second connection device by executing an image recognition processing on the first image.

5. The periphery monitoring device according to claim 1,
wherein the second acquisition unit acquires the height information via an operation input unit provided in the vehicle.

6. The periphery monitoring device according to claim 1,
wherein the second acquisition unit acquires the height information by executing a stereo image processing on the first image.
